(19) United States
(12) Patent Application Publication
(10) Pub. No.: US 2026/0266347 A1
(43) Pub. Date: Sep. 10, 2026

(54) METHOD AND KIT FOR REPLACEMENT OF A BRAKE PAD OR BRAKE JAW INSTALLED IN A VEHICLE BRAKE SYSTEM

(71) Applicant: ITT ITALIA S.R.L., Lainate (Milano) (IT)

(72) Inventors: Alberto Peverengo, Bagnolo Piemonte (Cuneo) (IT); Mattia Solari, Luserna San Giovanni (Torino) (IT); Alessandro Vacchina, Saluzzo (Cuneo) (IT)

(21) Appl. No.: 18/992,940

(22) PCT Filed: Jul. 17, 2023
(86) PCT No.: PCT/EP2023/069754

§ 371 Date: Jan. 9, 2025

(30) Foreign Application Priority Data
Jul. 28, 2022 (IT) 102022000016083

(51) Int. Cl. F16D 66/00; F16D 65/092

(52) U.S. Cl. CPC F16D 66/00; F16D 65/092; F16D 2066/001; F16D 2066/005; F16D 2250/0084

(57) ABSTRACT

The method of replacing a brake pad or brake jaw installed in a braking system of a vehicle, wherein the brake pad or brake jaw installed comprises a friction material block and a metal back plate (100) of the friction material block (300), comprises the following operations:—obtain technical specifications of the installed brake pad or brake jaw including at least the shape and size of the installed metal back plate;—reproduce a metal back plate (100) with the acquired technical specifications of shape and size and fit it with a fingerprint (110);—assembling a smart brake pad or brake jaw (400) by means of fixing in said fingerprint (110) of a board (200) with a printed circuit board presenting at least one force sensor (201) and/or one temperature sensor and a connector (210) and applying a block of friction material (300) to the reproduced metal back plate (100);—providing a replacement kit (1) comprising said smart brake pad or brake jaw (400), an electronic module (240) comprising a processing unit and a transmitter for transmitting and processing information received from said at least one force sensor (201) and/or temperature sensor, a physical interface (410) for mechanical and electrical connection between said electronic module (240) and connector (210), a software application (420) installable in a mobile electronic device configured to interact with said electronic module (240).

The present invention relates to a method and a kit for replacing a brake pad or brake jaw installed in a vehicle brake system.

As is well known, the automotive sector has gradually evolved towards solutions that guarantee the greatest possible driving safety both to minimise the number of accidents on the roads and to reduce the danger of accidents that cannot be avoided.

The safety devices introduced are of different types, from seat belts to airbags.

Many safety devices are variously related to the braking system, e.g. wheel anti-lock braking systems, vehicle stability control systems, etc.

Recent years have seen a proliferation of new technologies implemented on brake systems to increase driving safety.

New technologies have made new cars more and more intelligent thanks to an increasingly advanced sensor system, but the problem remains how to adapt the brake system to the highest safety standards in relation to the existing car fleet.

The technical task the present invention proposes is, therefore, to effectively update the braking system of today's motor vehicles so that it can be ‘retrofittable’, i.e. potentially usable on all vehicles on the market today but also on new vehicles, and in particular for the disc brake but also for the drum brake.

As part of this technical task, one purpose of the invention is to upgrade the braking system in such a way as to improve vehicle safety.

Another purpose of the invention is to provide an update system capable of providing predictive monitoring and diagnostics of the brake system.

Another purpose of the invention is to upgrade a braking system in such a way as to improve vehicle handling and the driving experience.

The technical task, as well as these and other purposes, according to the present invention are achieved by realising a method of replacing a brake pad or a brake jaw installed in a braking system of a vehicle, wherein the installed brake pad or brake jaw comprises a block of friction material and a metal back plate of the block of friction material, characterised by comprising the following operations:
acquiring technical specifications of the installed brake pad or brake jaw including at least the shape and size of the installed metal back plate;
reproducing a metal back plate with the acquired technical specifications of shape and size and providing it with a fingerprint;
assembling a smart brake pad or brake jaw by fixing a printed circuit board with at least one force sensor and/or temperature sensor and a connector in said fingerprint and applying a block of friction material to said reproduced metal back plate;
providing a replacement kit comprising said smart brake pad or brake jaw, an electronic module comprising a processing unit and a transmitter for transmitting and processing information received from said at least one force sensor and/or temperature sensor, a physical interface for mechanical and electrical connection between said electronic module and said connector, a software application installable in a mobile electronic device configured to interact with said electronic module.

Advantageously the replacement kit includes access via said software application to an IT Cloud computing architecture or preferably to an IT Edge computing architecture.

Access to the Cloud or Edge computing architecture can take place via the cellular communication network or other long-range telecommunication systems interconnected to cloud networks.

In a preferred mode of realisation, the Cloud or Edge computing architecture is configured for the comparison of a community of users who have replaced a brake pad (or a brake jaw).

Cloud or Edge computing can be used to compare the values measured by the sensors with ‘normal’ reference values for a given vehicle category or model.

Through Cloud or Edge computing, data from the mobile-type electronic devices of users with the kit mounted on the vehicle are processed and generate a response including reports and/or alerts automatically sent to the mobile-type electronic devices.

Advantageously, Edge computing makes for a rapid response to the appearance of a potential danger to the user.

Preferably, said software application processes said information for alerts via said mobile device.

Preferably, said processing unit of said electronic module processes said information to process alerts via said mobile device.

The present invention also discloses a replacement kit for a brake pad or brake jaw installed in a braking system of a vehicle, wherein the installed brake pad or brake jaw comprises a block of friction material and a metal back plate of the block of friction material, characterised by comprising:
a smart brake pad or brake jaw comprising a block of friction material, a metal back plate reproduced in the shape and size of a metal back plate of the installed brake pad or brake jaw and additionally presenting a fingerprint where a printed circuit board is attached presenting at least a force sensor and/or a temperature sensor and a connector;
an electronic module comprising a processing unit and a transmitter for the transmission and processing of information received from said at least one force sensor and/or temperature sensor;
a physical mechanical and electrical connection interface between said electronic module and said connector;
a software application installable in a mobile electronic device configured to interact with said electronic module.

The brake system in which the work is carried out may therefore include both a disc brake and a drum brake, in which case the brake pad with its metal back plate will be replaced by a drum brake jaw.

To this end, and to avoid further repetition, the term ‘brake pad’ used in this description is to be understood in an extensive sense to include not only the brake pad proper of a disc brake but also a jaw of a drum brake.

The kit is supplied to an installer to replace the brake pad installed on the vehicle with the smart brake pad.

In the case of a new vehicle, on the other hand, the invention provides a kit for installing a smart brake pad or brake jaw in the braking system of the new vehicle, wherein the smart brake pad or brake jaw comprises a block of friction material, a metal back plate of the block of friction material, and a printed circuit board presenting at least one force sensor and/or a temperature sensor and a connector, the installation kit being characterized by comprising an electronic module comprising a processing unit and a transmitter for transmitting and processing information received from said at least one force sensor and/or temperature sensor; a physical interface for mechanical and electrical connection between said electronic module and said connector; a software application installable in a mobile-type electronic device configured to interact with said electronic module; and access to a Cloud or Edge computing via said software application.

Other features of the present invention are also defined in subsequent claims.

Further features and advantages of the invention will become more apparent from the description of a preferred but non-exclusive method and kit for replacing a brake pad or brake jaw installed in a braking system of a vehicle according to the invention, illustrated by way of illustration and not limitation in the accompanying drawings, in which

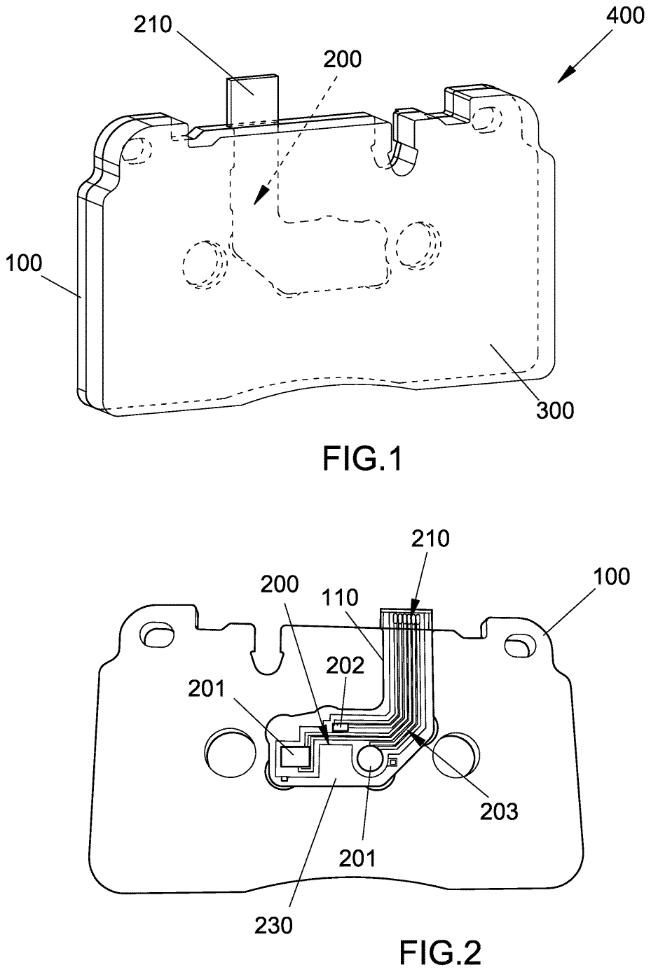

FIG. 1 shows a smart brake pad provided in the replacement kit;

FIG. 2 shows the metal back plate of the smart brake pad from FIG. 1 with the circuit board attached;

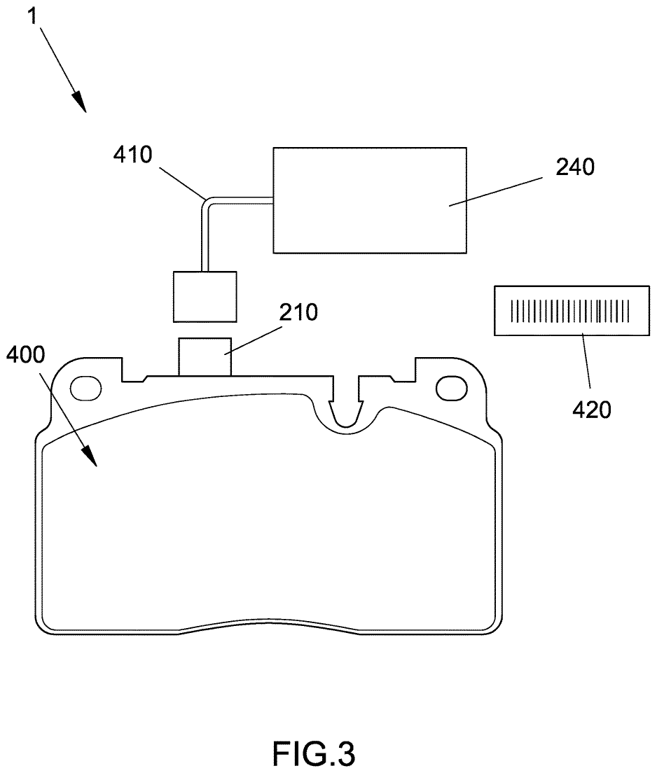

FIG. 3 shows the kit including the smart brake pad from FIG. 1; and

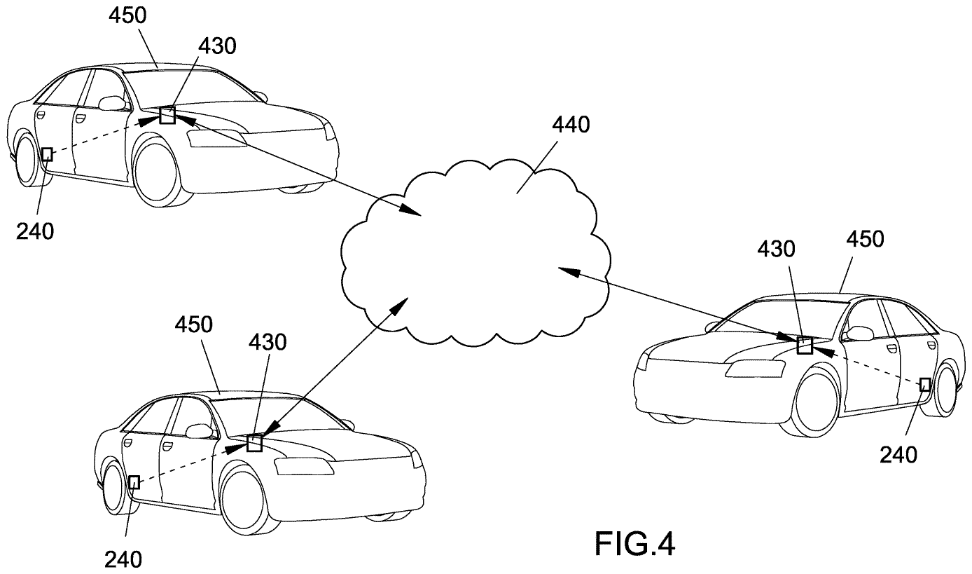

FIG. 4 shows cloud edge computing accessible via software applications.

With reference to the above-mentioned figures, a replacement kit for a brake pad installed in a vehicle brake system is shown, indicated overall by reference number 1.

This kit 1 is particularly suitable for brake system upgrades in the automotive aftermarket.

The braking system of the vehicle is of the type comprising, for at least one wheel of the vehicle, a disc or drum brake known to include brake pads or brake jaws consisting of a metal back plate and a block of friction material applied to the metal back plate.

In the following, for simplicity's sake, we will refer to a brake pad as an example, but the same concepts are applicable to a brake jaw.

The replacement kit advantageously includes an smart brake pad 400.

The smart brake pad 400 comprises a metal back plate 100, a circuit board 200, and a block of friction material 300 mounted on the metal back plate 100.

If necessary, a damping layer can be provided between the friction material block 300 and the circuit board 200.

The board 200 has one or more force sensors 201, particularly of the piezoelectric type, and/or a temperature sensor 202, electrically connected via conductive traces 203 in the circuit board to an external connector 210 of the smart brake pad 400.

Force sensors 201 can include normal force sensors and/or shear force sensors.

The force sensors 201 and conductive traces on the circuit board 220 can be realised by subsequent screen-printing operations.

Board 200 also has a support 230 made of an appropriate rigid material, for example, but not necessarily, stainless steel, which gives it the shape, size, protection and handling characteristics necessary for the implementation and use of board 200 in the smart brake pad 1.

The metal back plate 100 has an imprint 110 where the board 200 is fixed.

In particular, the metal back plate 100 has a fingerprint 110 with conjugate form to that of the support 230 of the board 200, within which the board 200 is positioned and fixed.

In the smart brake pad assembly 1, board 200 is interposed between back plate 100 in fingerprint 110 and friction material block 300.

Kit 1 further comprises an electronic module 240 comprising a processing unit and a transmitter, e.g. a wireless transmitter and in particular a radio transmitter, for transmitting and processing information received from the sensors 201, 202 installed in the smart brake pad 400, and a physical interface 410 for mechanical and electrical connection between the electronic module 240 and the connector 210.

Kit 1 also includes a software application 420 that can be installed in a mobile-type electronic device 430.

The software application 420 is configured to interact with the electronic module 240 to process the information provided by the sensors 201, 202 from which to process via the mobile electronic device 430 one or more alerts, preferably warning signals perceptible to a user driving the vehicle.

Alerts preferably consist of sound signals so as not to distract the visual attention of the driver.

Kit 1 includes access to a Cloud or preferably Edge computing computer 440 via the 420 software application.

The physical interface 410 may include a flexible cable.

The electronic transmitter 240 may include a wireless communication port and/or a wired communication port.

A wireless communication port can support Bluetooth technology.

A wired communication port can support USB technology.

The method of replacing the brake pad of a vehicle brake system includes the following operations.

Initially, technical specifications are obtained for the brake pad of the vehicle 450 to be replaced, including at least the shape and size of its metal back plate.

The metal back plate 100 is then reproduced with the acquired technical specifications of the shape and size of the metal back plate of the brake pad to be replaced.

The metal back plate 100 is reproduced with the addition of fingerprint 110.

The smart brake pad 400 is then assembled by fixing the PCB 200 in the fingerprint 110 and applying the friction material block 300.

Now kit 1 containing the smart brake pad 400, the electronic transmitter 240, the physical interface 410, the software application 420 is assembled.

The physical components of kit 1 can be packed in a package with additional accessories for installation.

Of course the software application 420 with access to Cloud or Edge computing 440 can be provided in the form of credentials to be downloaded to the mobile electronic device 430 directly via the Internet.

The mobile electronic device 430 is preferably a smartphone.

The physical components of kit 1 are preferably supplied to authorised workshops where brake pad replacement takes place.

After replacement, the smart brake pad 400, thanks to its sensor technology, can provide important information in real time, e.g. on its state of wear and/or its possible state of overheating and/or its possible residual torque, i.e. the torque recorded in the absence of brake activation.

At least important information can be processed by the software application as immediately perceptible warning signals without distraction from driving, thus in particular sound signals generated by a loudspeaker of the mobile electronic device 430 and e.g. indicative of the attainment of a threshold temperature of the brake pad 400 or the attainment of a threshold thickness reduction of the friction block 300, or the attainment of a threshold residual torque.

Other, less important information with regard to vehicle safety can also be stored and processed and made available at a later date, and in this case not necessarily in the form of audible signals but also as image representations on a display of the mobile electronic device 430.

Advantageously, the information from the sensors 201, 202 can be processed not only by the software application but also, at an earlier level, by the processing unit of the electronic module 240, again with the purpose of generating alerts for the user which will be made available via the mobile-type electronic device 430; the alerts will be available immediately if the mobile-type electronic device 430 is already switched on or will in any case be available as soon as it is switched on.

In addition, the architecture of Cloud or Edge computing computing 440 can be configured for comparison between users in a community of users who have replaced a brake pad.

In particular, through Cloud or Edge computing 440 users can compare the performance of smart brake pads, their respective driving styles and get statistical information or advice to improve safety or their driving style, and eventually the data collected can be made accessible to manufacturers to improve the product.

If the vehicle is new, the installation kit for the smart brake pad or brake jaw, sensing as described above, always includes the electronic module comprising the processing unit and transmitter for transmitting and processing information received from the sensors, the physical interface for mechanical and electrical connection between the electronic module and the connector, and the software application installed in the mobile electronic device configured to interact with the electronic module; and access to Cloud or Edge computing via the software application.

The method and kit for replacing the braking system of a vehicle thus conceived are susceptible to numerous modifications and variations, all of which fall within the scope of the inventive concept; furthermore, all details are replaceable by technically equivalent elements.

In practice, the materials used, as well as the dimensions, can be any according to requirements and the state of the art.

1. A method for replacing a brake pad or a brake jaw installed in a braking system of a vehicle, in which the brake pad or brake jaw installed comprises a block of friction material and a metal back plate of the block of friction material, the method comprising:
acquiring the technical specifications of the brake pad or brake jaw installed including at least the shape and dimension of the installed metal back plate;
reproducing a metal back plate with the acquired technical shape and dimension specifications and providing the metal back plate with a fingerprint;
assembling a smart brake pad or brake jaw by fixing in said fingerprint a board with a printed circuit having at least one force sensor and/or temperature sensor and a connector and applying a block of friction material to said reproduced metal back plate; and
providing a replacement kit including said smart brake pad or brake jaw, an electronic module comprising a processing unit and a transmitter for transmitting and processing information received from said at least one force sensor and/or temperature sensor, a physical interface for mechanical and electric connection between said electronic module and said connector, a software application that is installable in an electronic device of movable type configured to interact with said electronic module.

2. A replacement method according to claim 1, wherein the kit includes an access via said software application to a Cloud or an Edge computing system.

3. A replacement method according to claim 1, wherein the Cloud or Edge computing system is configured to process said information with other information and process reports and/or alerts automatically that are sent to said electronic device of movable type.

4. A replacement method according to claim 1, wherein the software application is configured to process said information and process alerts via said device of movable type.

5. A replacement method according to claim 1, wherein the processing unit for processing said electronic module is configured to process said information and process alerts via said device of movable type.

6. A replacement kit for replacing a brake pad or a brake jaw installed in a braking system of a vehicle, wherein the brake pad or brake jaw installed comprises a block of friction material and a metal back plate of the block of friction material, the replacement kit comprising:
a smart brake pad or brake jaw comprising a block of friction material, a metal back plate reproduced with the shape and dimension of a metal back plate of the brake pad or brake jaw installed and further having a fingerprint in which a board is fixed with a printed circuit having at least one force sensor and/or a temperature sensor and a connector;
an electronic module comprising a processing unit and a transmitter for transmitting and processing information received from said at least one force sensor and/or temperature sensor;
a physical interface for mechanical and electric connection between said electronic module and said connector; and
a software application that is installable in an electronic device of movable type configured to interact with said electronic module.

7. A replacement kit according to claim 6, wherein the replacement kit includes an access to a Cloud or an Edge computing system via said software application.

8. A replacement kit according to claim 6, wherein the physical interface includes a flexible cable.

9. A replacement kit according to claim 6, wherein the electronic module includes a wireless communication port.

10. A replacement kit according to claim 6, wherein the electronic module includes a wired communication port.

11. A replacement kit according to claim 6, wherein the software application is configured to process said information from which to process alerts via said device of movable type.

12. An installation kit for installing a smart brake pad or brake jaw in a braking system of a new vehicle, in which the smart brake pad or brake jaw comprises a block of friction material, a metal back plate of the block of friction material, and a board with a printed circuit having at least one force sensor and/or a temperature sensor and a connector; wherein the installation kit comprises: an electronic module comprising a processing unit and a transmitter for transmitting and processing information received from said at least one force sensor and/or temperature sensor; a physical interface for mechanical and electric connection between said electronic module and said connector; a software application that is installable in an electronic device of movable type configured to interact with said electronic module; and an access to a Cloud or an Edge computing system via said software application.
